(19) United States
(12) Patent Application Publication
(10) Pub. No.: US 2016/0343098 A1
(43) Pub. Date: Nov. 24, 2016

(54) METHOD AND SYSTEM FOR MEASUREMENT OF STUDENTS', TEACHERS' AND EDUCATIONAL INSTITUTIONS' PERFORMANCE

(71) Applicants: Mitesh Praveenchandra PATEL, Maharashtra (IN); Dushyant Pravinchandra PATEL, Maharashtra (IN)

(72) Inventors: Mitesh Praveenchandra PATEL, Maharashtra (IN); Dushyant Pravinchandra PATEL, Maharashtra (IN)

(21) Appl. No.: 15/112,138

(22) PCT Filed: Jan. 17, 2014
(86) PCT No.: PCT/IN2014/000034

§ 371 Date: Jul. 15, 2016

(51) Int. Cl. G06Q 50/20; G06Q 10/06

(52) U.S. Cl. CPC G06Q 50/205; G06Q 10/06393; G06Q 10/06398

(57) ABSTRACT

The invention relates to a method and system for measurement of students' improvement, more particularly the method and system aims at devising a methodology for measurement of improvement as percentage of the improvement achieved to scope of maximum improvement possible in previous performance of a particular student. The invention also relates to a method and system for measurement of teachers and educational institutions' performance, more particularly the method and system aims at devising a methodology for measurement of performance based on percentage of the average improvement achieved to scope of maximum improvement possible in previous performance of a relevant group of students.

The invention relates to a method and system for measurement of students' improvement, more particularly the method and system aims at devising a methodology for measurement of improvement as percentage of the improvement achieved to scope of maximum improvement possible in previous performance of a particular student.

The invention also relates to a method and system for measurement of teachers and educational institutions' performance, more particularly the method and system aims at devising a methodology for measurement of performance based on percentage of the average improvement achieved to scope of maximum improvement possible in previous performance of a relevant group of students.

The Invention is also referred to as MDPI (Mitesh Dushyant Performance Index) in the following paragraphs.

### BACKGROUND OF INVENTION

It is a common event in most schools, classes and homes too where the teachers and parents declare some scheme for the students. It is something like, “If you score say 90% marks in Mathematics, you will be entitled to a special reward”. In such a scenario a student who is not already near about that percentage does not even pay attention to such a reward since they are very well aware that they will not be able to achieve that percentage of marks and the students who are already near about that percentage generally are not motivated since it is easy for them to score such a percentage. If there were a methodology whereby all the students irrespective of their caliber and capability are motivated, it would be a very ideal methodology.

Let us try to analyze a hypothetical situation of a class where there are 60 students. Out of these, 5% students (i.e. 3 of them) are scoring above 90% marks. Another 10% of them (i.e. 6 more) are scoring 80%. The remaining 51 students might never have scored more than 80%. Nor do they have an urge to achieve this level. Many of them might be in the range of 35% to 60% or so.

Now let us consider the day to day motivational techniques used by the teachers to encourage the students for better results. If these techniques were really very effective, the students would have certainly higher morale and they would perform better. But that is not normally observed. For the toppers, the target is to achieve full marks. They are rather self-motivated to achieve that level. There are others who have been scoring 60% to 70% marks and have a perspective in their minds to achieve say 90%. If a gradual effort is put on them, it will be a step by step improvement which will be comparatively easier for them to understand and they will put a consistent effort in the process of improvisation.

For a student who achieved 90% in the earlier examination and now scored say 94%, the improvement is not just 4% as normally computed by everyone. The scope for improvement was 10%, out of which he or she achieved 4%, which is an improvement of a substantial nature and that is to the tune of 40%! This kind of computation is certainly going to improve the motivational level of the student and everyone except a person achieving 100 out of 100 consistently, all will be able to register some growth and development in achievements. It is necessary to accept the fact that all cannot achieve 100 out of 100 marks every time and therefore it is necessary to keep them motivated all the time. There is no second opinion about the fact that students need to be encouraged and motivated to ensure better results in their studies.

The common practice of calculating student performance is in absolute terms. This lacks the power of inspiration which is so very essential for the students. The efforts are made to create this motivation for the entire class and will ensure that better scoring is not the monopoly of a few students but over a period of time can be within reach of a common student as well. Each one will try to focus and strive for excellence through small achievements on a gradual basis, finally leading to a substantial growth in the marks.

A self motivation system creates better student life. Most of the times, the competition amongst the toppers is fierce and leads to jealousy, bad interpersonal relationships, hatred and all such negative issues. The second and third number students are envious of the No. 1 and many other discussions initiate. Many times it is worthless as the results seldom change. The topper faces an allegation that he or she was the most favourite of the teachers and they made a favour by awarding the topmost position in the class. The sincere efforts of the topper are neglected by other students and a meaningless discussion starts. Even the topper cannot enjoy his achievement and success. On one side the teacher announces in the class about the best performance and advises other students to learn something from him or her. The very next moment, the envy begins snatching away the happiness of achieving top ranking.

The teacher's announcement does not motivate many others in the class. The students listen to it for a few minutes as a routine. Everyone congratulates the toppers as a sheer formality and the old routine continues without exception. It is possible to produce the desired change in this situation. The best thing to introduce in the academics is that it will eradicate the feeling of Inferiority Complex. This feeling is so much common particularly amongst the low performers that they just assume that they are never going to perform better. They think that top positions are RESERVED for some specially blessed students and it is impossible that they can ever achieve it. When the concept of this invention is sown deep into the mind, it will produce a great tree on which various types of fruit will be produced. The very feeling that I can produce better results by competing against my own past performance will replace the inferiority complex by a well-defined mental balance which will be based on a fair opportunity to everyone.

The marking system functions on absolute numbers. In most cases, students topping the class in their primary education continue to do so even in their secondary education. Those unable to secure good marks in primary section are seen to lag behind even in the higher studies. There may be some exceptions of course to this point. Those who get proper guidance and understand the importance of better scoring in studentship may start performing better at a later stage. But here we are more concerned about the masses and their mentalities towards educational field. A consistent effort to enhance their performance through the method and system according invention go a long way in creating better performances. The present methods of Awards and Rewards to toppers fail to encourage many a students; in fact they tend to demotivate many. The materialistic attractions put before the students by way of small awards and appreciations are no more important to them. Thus the efforts of teachers, parents and schools become futile to prove their efficacy in improving the performance. This is precisely the point where the method of this invention comes to the rescue of parents as well as teachers and their schools.

### PRIOR ART

Paper is published document, by OECD (organisation for economic co-operation and development)/CERI (centre for education research and innovation) at international conference “learning in the 21^{st} century research, innovation and policy”, regarding assessment for learning and formative assessment.

A magna publication document regarding tips for encouraging student participation in classroom discussions.

An Oxford Brookes University publication document regarding selecting method assessment.

A hand book from the Office of Academic Planning & Assessment of university Massachusetts Amherst.

A hand book “Student Learning outcomes Assessment Hand book by Montgomery collage, Montgomery County, Maryland.

A published document “Five key ingredients for improving student motivation” by research in higher education journal by Kaylene C. Williams of California state university, stanislaus and Caroline C. williams, University of Wisconsin, Madison. U.S. Pat. No. 5,829,983 patent document relates system for carrying out educational management.

U.S. Pat. No. 6,790,045 B1 patent document relates to method and system for analysing student performance inan electronic course.

These above referred prior art documents are not having any features of invention to give self motivation and not dealing with the features of invention. Therefore the invention concept is totally new.

### OBJECT OF THE INVENTION

It is an object of the invention to devise a method and system for measurement of a students' improvement which will make them self motivated to show a consistent improvement in their performance.

It is another object of the invention to devise a method and system for measurement of performance of a teacher or a group of teachers which will motivate them to show an improved performance over a period of time.

One more object of invention to devise a method and system for measurement of performance of an educational institution or a group of institutions which will motivate them to show an improved performance over a period of time.

### STATEMENT OF THE INVENTION

Accordingly the invention provides A method and system for measurement of students improvement comprises step of:
a) Recording the marks obtained by the a student in the previous examination;
b) calculating the maximum improvement possible (difference between maximum marks that is 100 percent less the marks obtained by the student in the previous examination) (say “b”)
c) recording the marks in the current examination of the student;
d) calculating the difference between the current examination and the previous examination marks of a student (say “d”)
e) Calculating the percentage of change of the marks of the student to the scope of maximum improvement possible for the student (“d”/“b”×100)

The above methodology may also be used to measure improvement in a particular subject or a group of subjects.

In respect of teachers the invention provides a method and system for measurement of a teacher's performance comprises step of:
a) recording average marks obtained by the relevant group of students in the previous examination;
b) calculating the maximum improvement possible in the group (difference between maximum marks that is 100 percent less the average marks obtained by the group of students in the previous examination) (say “b”)
c) recording the average marks in the current examination of the group of students;
d) calculating the difference between averages of the current examination and the previous examination marks of a group of students (say “d”)
e) Calculating the percentage of change of the average marks of the group of students to the scope of maximum improvement possible for the group of students. (“d”/“b”×100)

Similarly, the above steps are followed to measure performance of a teacher subject wise and also between or amongst the teachers irrespective of the subject taught by them.

Similarly, this methodology may be applied to measure performance of a teacher on a year on year basis or between or amongst the teachers on a year on year basis.

In respect of educational institutions the invention provides a method and system for measurement of an educational institutions performance comprises step of:
a) recording average aggregate marks obtained by the students of a particular educational institution in the previous examination;
b) calculating the maximum improvement possible for the students of the educational institution in the group (difference between maximum marks that is 100 percent less the average aggregate marks obtained by the students of the educational institution in the previous examination) (say “b”)
c) recording the average aggregate marks in the current examination of the students of the educational institution;
d) calculating the difference between averages of the current examination and the previous examination aggregate marks of the students of the educational institution (say “d”)
e) Calculating the percentage of change of the average aggregate marks of the students of the educational institution to the scope of maximum improvement possible for the students of the educational institution. (“d”/“b”×100)

Similarly, this methodology may be applied to measure performance of an educational institution on a year on year basis or between or amongst the educational institutions on a year on year basis.

Additionally, this methodology may also be used to measure deterioration of performance of one or more students or teachers or institutions.

### DESCRIPTION OF INVENTION

The invention, a method and system of invention, induces a student to focus on competition against his own previous performance, the student is self-motivated.

The importance of self-motivation need not be over-emphasized since it is a well-accepted fact that only the self-motivation lasts longer and is having immense potential of creating unprecedented performances! The method and system of invention offers a uniform strategy to each and every student without discrimination. It can positively induce the students, parents and teachers too to keep a fair target every time and attempt to attain it. The inspiration will be profound treating all at an equal level and respecting one another's achievements, while simultaneously giving a guideline where one falls short of effort and needs improvement. This will also help students get rid of stress and strain of studies and the competition will become healthier. In fact peer groups of students will influence the performance of one another enhancing the results. Instead of envy and hatred, students will edify one another and start appreciating the achievements of others. The success of others will become a matter of motivation to many others. All students will be on equal footing and will have the opportunity to stand first.

Invention as a as a Measurement of Improvement of a Student:

The invention namely, MDPI works as a measurement of Improvement of any student. Here is sn example:

Student A

Previous Year Marks: 75%

Current Year Marks: 82%

Step 1: Recording of previous year marks. It is 75.

Step 2: Calculating difference of previous year marks and maximum marks that can be obtained. Hence 100−75 i.e. 25 (Say A)

Step 3: Recording of current year marks. It is 82.

Step 4: Calculating the difference between Current Year Marks & Previous Year Marks.

It is 82−75 i.e. 7 (Say B)

Step 5: Measurement of Improvement (MDPI) =A/B×100=7/25×100 =28% Here we can say that Student A has improved 28% on his previous performance.

Student B

Previous Year Marks: 90%

Current Year Marks: 92%

Step 1: Recording of previous year marks. It is 90.

Step 2: Calculating difference of previous year marks and maximum marks that can be obtained. Hence 100−90 i.e. 10 (Say A)

Step 3: Recording of current year marks. It is 92.

Step 4: Calculating the difference between Current Year Marks Previous Year Marks.

It is 92−90 i.e. 2 (Say B)

Step 5: Measurement of Improvement (MDPI)=A/B×100=2/10×100=20%

Here we can say that Student B has improved 20% on his previous performance.

Looking at the improvements of Students A & Student B; we can say that improvement of Student A is higher than the Student B. As such MDPI is the measurement of improvement rather than that of absolute figures. As such it gives equal opportunity to each and every student to perform better in MDPI index irrespective of their current status.

MDPI works as a tool in the hands of teacher to motivate all students at a time in a unique way.

Earlier to it, teachers have no other option except to give students targets/challenges in absolute terms. We have seen it will not motivate all students at a time. For eg. Teachers normally talks with a class of 50 students in this fashion 1.“Whoever gets more than 85 marks, I will give them chocolate.” (or any other thing). 2. “Whoever gets first rank, I will give him/her a prize”, or any other statements which teachers in day to day life used to make student perform better.

Now we analyze both the scenario in detail. In first case, those students who are already getting 85 & above are least bothered about it. Further students who usually gets more than 90; target/challenge of 85 is of no use at all. Consider students who are scoring between 60 to 75; for them also getting 85 is very tough target. And hardly few of them are actually inclined to achieve this target and achieving the target is a farthest thing. For students who are getting 60 or less marks, 85 is just like a dream. They are least affected by above statement. Remaining students who are getting between 75 to 90 are those students; who are actually gets motivated by above statement. But then its only 10 to 15% of total population.

Scene is very dissatisfactory in second case. Students who are getting 1^{st} to 5^{th} rank are the students who takes up above challenge. As such very small portion of the population gets motivation from above statement. Majority of the students are out of the Rank race and they are not at all buy into this statement.

We will analyze both the scenario modified through MDPI.

In wake of MDPI; teacher can make following statement in first case “Students who will get 25% or more on MDPI index will get chocolate from me.”

Now analyze the above scenario. What happens when teacher uses MDPI? Though the teacher is making above statement in general in class of 50 students; he is talking to each & every student individually. Index of 25% on MDPI means improving on the previous performance of self for each student. This means student who has got 92 previously has to improve his/her marks by 25% i.e. by 2 marks and S/he has to get 94 marks now. Similarly, student who has got 80 previously has to improve his/her marks by 5 marks i.e. S/he has to get 85 marks now. In the same way, student who has got 60 previously has to improve his/her marks by 10 marks i.e. S/he has to get 70 marks now. Likewise though teacher has given one target to all students, it will vary from student to student in absolute terms. Therefore it makes it challenging for all the students on one side and on the other side it is achievable by all also. As such MDPI becomes perfect motivating tools in the hands of teachers.

In wake of MDPI; teacher can make following statement in the second case “Students who will get first rank on MDPI index, I will give him/her a prize.”

Now analyze the above scenario. What happens when teacher uses MDPI as a ranking tool? As MDPI gives each and every student separate targets based on their previous performance. It is one of the best tool whereby each & every student has equal chance to get first rank. Ranking on MDPI will not remain same all the time. It has a tendency to change from time to time, as nobody can improve constantly at the similar pace for a consistent period of time else s/he will get full marks which is not possible for all. As such pace of improvement keeps on changing from time to time for all students. Therefore ranking on MDPI index keeps on changing and gives all students equal opportunity irrespective of his/her previous performance. And as such cultivate the habit of consistent improvement over previous performance.

Hence while teacher announces special prize for first rank on MDPI, everybody feels in the same manner. The post is not reserved for selected few and also anybody belonging to any category can garner the above place. Hence MDPI gives equal motivation to all the students at a time.

What happens when a student's performance deteriorates from the previous marks. Say for eg.:

Student A

Previous Year Marks: 80

Current Year Marks: 72

Step 1: Recording of previous year marks. It is 80.

Step 2: Calculating difference of previous year marks and maximum marks that can be, obtained. Hence 100−80 i.e. 20 (Say A)

Step 3: Recording of current year marks. It is 72.

Step 4: Calculating the difference between Current Year Marks & Previous Year Marks.

It is 72−80 i.e. −8 (Say B)

Step 5: Measurement of Improvement (MDPI)=A/B×100=−8/20×100=−40% Here we can say that Student B has negative improvement of −40% on his previous performance.

MDPI is a very useful analytical tool in the hands of teachers. They can now easily grab those students who are improving and students who are weakening. Students with negative MDPI index is of real concern for teachers in a way that it highlights students who are not getting the things well. Might be teacher can think of change in method of teaching or bringing in creativity to make such students perform better. Before MDPI, teachers normally go through normal absolute figures. In those scenario, teacher has to remember earlier performances of all students and compare with current performances to get the idea of above things. It is not possible for all the teachers and in larger batches it is further difficult for teachers to make such assessment. Further consider following scenario. A student who is getting 90 to 95 marks regularly. If s/he gets 85 marks, s/he easily escapes teacher's eye as 85 is still a good figure. In the same way, we can consider for student getting 80, 70, 60 or any number who gets less marks than their previous performances. They were not easily identifiable earlier. However MDPI index shows out slightest negative improvement for any student. Thus MDPI gives a clear picture to the teacher.

MDPI as a Measurement of Teacher's Performance:

MDPI works as a measurement of Teacher's Performance. Here is the example:

Consider a class of 5 Students taught by Teacher T in Mathematics. Student A, B, C, D & E

Their Previous Year Marks in Maths: A-50%, B-60%, C-70%, D-80% and E-90%

Their Current Year Marks in Maths: A-65%, B-73%, C-65%, D-84% and E-93%

Step 1: Recording of previous year marks and taking its average. It is A-50%, B-60%, C-70%, D-80% and E-90% accordingly average marks for previous year are (50+60+70+80+90)/5=350/5=70

Step 2: Calculating difference of previous year average marks and maximum marks that can be obtained. Hence 100−70 i.e. 30 (Say A)

Step 3: Recording of current year average marks. It is A-65%, B-72%, C-65%, D-82% and E-93% and accordingly average marks for current year are (65+73+65+84+93)/5=380/5=76

Step 4: Calculating the difference between Current Year Average Marks & Previous Year Average Marks.

It is 76−70 i.e. 6 (Say B)

Step 5: Measurement of Teacher's Performance in Teaching Maths (MDPI)=A/B×100=6/30×100=20% Here we can say that performance of Teacher T in teaching Mathematics is 20% .

Now consider a another class of 5 Students taught by Teacher S in Mathematics. Student J, K, L, M & N

Their Previous Year Marks in Maths: J-55%, K-65%, L-75%, M-85% and N-92%

Their Current Year Marks in Maths J-70%, K-68%, L-72%, M-90% and N-96%

Step 1: Recording of previous year marks and taking its average. It is J-55%, K-65%, L-75%, M-85% and N-92% accordingly average marks for previous year are (55+65+75+85+92)/5=372, 6=74.40

Step 2: Calculating difference of previous year average marks and maximum marks that can be obtained. Hence 100−74.40 i.e. 25.60 (Say A)

Step 3: Recording of current year average marks. It is J-70%, K-68%, L-72%, M-90% and N-96% and accordingly average marks for current year are (70+68+72+90+96)/5=396/5=79.20

Step 4: Calculating the difference between Current Year Average Marks & Previous Year Average Marks.

It is 79.20−74.40 i.e. 4.80 (Say B)

Step 5: Measurement of Teacher's Performance in Teaching Maths (MDPI)=A/B×100=4.80/25.60×100=18.75%

Here we can say that performance of Teacher S in teaching Mathematics is 18.75%.

As MDPI is the measurement of Teachers Performances, we can say that Teacher T has taught better than Teacher S. Earlier to MDPI, Teachers Performances has been normally judged from the highest marks garnered by any of his/her students. In that case, We could have been easily come to conclusion that Teacher S is more effective as Student N has highest marks in both classes i.e. 96%. Further in the class of 30 or more than 30 students, judging Teaching effectiveness based on one or few students achievement can give us distorted picture. It can be due to individual performances of any one or few students and not because of teachers teaching ability. However in case of MDPI, we take all students performances at a time. In a way students who have negative improvement are also taken into consideration. As such MDPI gives us a very clear picture of Teaching effectiveness of any teacher.

In MDPI, it's not necessary that we should compare teachers of same subject. As MDPI gives measurement of Teaching Effectiveness irrespective of subject being taught, we can compare any subject teacher's performance with any other subject teacher. For eg., in the above referred scenario, if we consider that Teacher T is teaching Maths and Teacher S is teaching say Languages. Then also we can say that Teacher T's performance is better than Teacher S's performance. Here one can argue that students usually get higher marks in practical subjects than in theory subjects. But we have to remember that MDPI is calculated based on previous performance of students in one subject at a time and comparing it with current marks in the same subject. As such if student are getting higher marks in Practical subjects, they should have got higher marks in previous year also. And accordingly it gets neutralized automatically.

So now education institute can calculate performance of all teachers teaching in its institute based on class or classes being taught by those teachers. And accordingly it will have a clear cut ranking of Teachers based on their MDPI performance index. Institute will be in better position to judge objective assessment of teaching effectiveness of all its teachers.

As we have seen in individual performance of a student, Teacher can also have negative measurement on MDPI index. In higher classes, it happens usually. Then also comparison and ranking is possible. For eg. Teacher T's performance is −15% and Teacher S's performance is −10%. In such case we can say that performance of Teacher S is better than Teacher T. It is very clearly evident from the MDPI index itself.

Earlier to MDPI, we have only subjective assessment tools of Teaching Effectiveness. However MDPI made it possible to assess Teaching Effectiveness in a objective manner. Hence benefits of objective assessment bound to follow. Like first of all teachers become conscious about their teaching. In absence of any proven assessment method, certain class of teachers is taking teaching very lightly. They are just looking at it from the perspective of earnings and forget about its main object i.e. imparting knowledge and improving understanding of the subject. After MDPI, such class of teachers will be easily pointed out. They have to put their best in order to score well in MDPI.

Teachers, who are really interested in teaching and innovative in their teaching style, can now analyze their teaching methods objectively. They can now judge which method is more effective than the other one as they will have ready assessment of it. As such, MDPI push them to be more innovative and improving their score on MDPI. This in turn ultimately helps students. They will get better quality of teaching.

### MDPI as a Measurement of Education Institute's Performance:

MDPI works as a measurement of. Education Institute's Performance. Here is the example:

Consider a Institute Y of 5 Students pursuing Course CE. Student A, B, C, D & E

Their Previous Year Aggregate % Marks in before entering in Course CE: A-50%, B-60%, C-70%, D-80% and E-90%

Their Current Year Aggregate % Marks in Course CE: A-65%, B-73%, C-65%, D-84% and E-93%

1: Recording of previous year aggregate % marks and taking its average. It is A-50%, B-60%, C-70%, D-80% and E-90% accordingly average aggregate % marks for previous year are (50+60+70+80+90)/5=350 /5=70

Step 2: Calculating difference of previous year average aggregate % marks and maximum aggregate % marks that can be obtained. Hence 100−70 i.e. 30 (Say A)

Step 3: Recording of current year aggregate % marks and taking its average. It is A-65%, B-73%, C-65%, D-84% and E-93% and accordingly average aggregate % marks for current year are (65+73-+65+84+93)/5=380/5=76

Step 4: Calculating the difference between Current Year Average Aggregate % Marks & Previous Year Average Aggregate % Marks.

It is 76−70 i.e. 6 (Say B)

Step 5: Measurement of Institute's Performance in Teaching course CE (MDPI)=A/B×100=6/30×100=20%

Here we can say that performance of Institute Y in teaching Course CE is 20%.

Now consider another institute Z of 5 Students pursuing same Course CE. Student. J, K, L, M & N

Their Previous Year Aggregate % Marks before entering in Course CE: J-55%, K-65%, L-75%, M-85% and N-92%

Their Current Year Aggregate % Marks in Course CE: J-70%, K-68%, L-72%, M-90% and N-96%

Step 1: Recording of previous year aggregate % marks and taking its average. It is J-55%, K-65%, L-75%, M-85% and N-92% accordingly average aggregate % marks for previous year are (55+65+75+85+92)/5=372/5=74.40

Step 2: Calculating difference of previous year average aggregate % marks and maximum aggregate % marks that can be obtained. Hence 100−40 i.e. 25.60 (Say A)

Step 3: Recording of current year average aggregate % marks and taking its average. It is J-70%, K-68%, L-72%, M-90% and N-96% and accordingly average aggregate % marks for current year are (70±68+72+90+96)/5=396/5=79.20

Step 4: Calculating the difference between Current Year Average Aggregate % Marks & Previous Year Average Aggregate % Marks.

It is 79.20−74.40 i.e. 4.80 (Say B)

Step 5: Measurement of Institute's Performance in Teaching Course CE (MDPI)=A/B×100=4.80/25.60×100=18.75%

Here we can say that performance of Institute Z in teaching Course CE is 18.75%.

As MDPI gives the measurement of Institutes Performances, we can say that Institute Y has done better than. Institute Z in Course CE. Earlier to MDPI, Institutes Performances have been normally judged from the closing % of students admitted in it in the last year. Say Institute Z has closing % marks of 90% and Institute Y has closing % marks of 85% in their respective admission procedure for the same course; it has been normally assumed Institute Z is better for that course than that of Institute Y. Higher closing % marks in admissions can be due to various factors like accessibility, course fees, institutes standing in the field, population in the vicinity of institute and many others. But by far these closing % marks in admissions are considered as benchmark of Institute's Teaching qualities. However, introduction of MDPI will change the whole scenario drastically. It will erase out all wrongful assumptions based on things not directly related to teaching quality. With the help of MDPI, all institutes performances can be measured objectively and it will give clear picture about the teaching quality and teaching environment provided by the institute. It will throw light on the quality of teachers faculty provided by the institute and effectiveness of various methods used by it in teaching. It's tendency of institute to show result of highest scorer of it in previous years. However this can also be misleading as performance of any one or few students cannot give us clear picture of the institute's performance. Now parents can choose on the basis of MDPI result of an institute in particular course, whether to admit their child into it or not. Thus MDPI will be of great help to the parents.

Further MDPI will be helpful for Institute also in judging its performances in various courses. Institute can now have better idea of its teaching faculty strength and weaknesses. Many of the institutes are innovative in teaching methods. They can now evaluate its various innovative methods. Also institute can copy teaching methods of other institutes which are giving better results.

As we have seen in individual performance of a student & Teacher, institutes can also have negative measurement on MDPI index. In higher classes, it happens usually. Then also comparison and ranking is possible. For eg. Institute Y's performance is −15% and Institute Z's performance is −10%. In such case we can say that performance of Institute Z is better than Institute Y. It is very clearly evident from the MDPI index itself.

### The Advantage of Invention for Creating a Passion of Self-Improvement:

While most students dream of success, only a few of them really succeed. Rest of them either opt out of the pace or race due to a short term failure or just give up without understanding the appropriate reason for the shortcoming. Winners wake up early and work hard to achieve their success. It is true that success cannot always be measured in terms of marks obtained or percentage scored. But still, at the end of the day, what matters is what you score, when it comes to staying ahead in the competitive world.

In such a rat race, one needs to be positive rather than doubtful, optimistic rather than fearful and must be rather determined than to be defeated. The invention of method and system for measurement of students' performance/A method and system for measurement of educational institutions' performance is an innovative thought which was a resultant formula of performance improvement of a brainstorming session between inventors. It gives everyone a fair opportunity to show progress, whether it be academic or can even be extended to non-academic concepts too.

Each one of us is a born unique person having unique features, characteristics, qualities and traits. That is the reason why we see so many variants of different personalities all over the world. The grasping, the basic understanding and the depth of knowledge of a person differs from person to person. However, despite this great limitation posed mostly by the natural abilities, there is always a scope for betterment. That was what was being sought by the invention by clarifying that one can improvise upon his past performance with the help of systematic efforts and still achieve newer heights of success. Here it is not a matter of competing with others, as is done all over the world. Here the competition is You Versus You. You need not compete with any one you should compete with your own self. Create this habit as a regular one and over a period of time, one will certainly enhance the skills by showing a definite improvement in the levels of achievement.

This formula is an opportunity offered to everyone who aims at competing with oneself and not compare his or her performance with anyone else. After each test undergone by the student, he is able to say: I gave my best efforts, I gave all I could to achieve the success. This creates a fighting spirit in the student, particularly the weaker ones who are always under the pressure of inferiority complex. With the advent of technology, the next generation of our country is becoming very active, very smart and achievement of preset goals is their passion. However, in the rat race faced in the actual educational market, the student has too many preoccupations in the life and many a times regular studies become a last priority. Again the fierce competition puts him on the back foot and this may lead to frustration. Frustration is nothing but the gap between the desired results and actually attained results. The more the gap, the worse is the situation faced by the student. Accordingly the invention method creates a situation wherein the pressure of competition is from within the student and not with outsiders. This puts him in a better comfort zone and can help in improving the performance substantially.

The invention method leads the student to carry out SWOT analysis of oneself. What are the strengths, what are the weaknesses, what are the opportunities available and what are the threats in achievement is the study carried out by student and he sets his own targets accordingly. All situations are ‘win win’ as the person stops competing with the outer world. He follows his own goals and leads himself to attaining the same. While performing, student learns many a things. In the process of improvement, he realizes that he is always stronger than what he thought about himself. This relieves the stress levels substantially and then the brain starts functioning better. In present circumstances, competition is treated as such a virtue and everyone is so busy competing, no one has the time for compassion. No matter how you perform, there is always someone with greater intelligence who makes a remark or opinion that your act was lousy. According to invention method, the main principle is to compete against yourself, about being better than you were the day before. The person continues to contribute a better effort to surmount yesterday's level of success. He thus strives for excellence rather than perfection as he knows that perfection is usually a theoretical possibility.

All this discussion does not mean that competition is useless. But for competition, there is no fun in the life. E.g. Competition is like the spice of sports activities. But if the spice becomes too much the entire meal will be a waste making one sick. It must be proportionately added and that is where the entire system in the world appears to be failing. We are unable to relate what is the precise level of tolerable competition. This makes everyone vulnerable to unethical and unacceptable practices too. Apart from this, there is also a fear that most persons indulging in focused competition have a tendency to end up into mediocrity. One ought to accept a fact that one has no control on what the other guys do. One can only have a control over what he himself does.

It may take some time to understand and implement the invention method formula in practice. But once a person really understands it, he can tide over bad situations faced earlier and move forwards with a greater determination and dedication. In fact, one can learn a lot from the past mistakes and misfortunes too. This leads to self-analysis and self-actualization and avoids recurring mistakes. Over a period of time, one gets closer and closer to his goals. This also leads to inner satisfaction of giving the best and probably receiving the desired results.

Most parents do not appreciate that individuals differ from one another in various ways. Their abilities to understand complex ideas, to adjust appropriately to the circumstances, learn from the environment, to react to the situations in an apt way and so on. Their potentials vary considerably and that is why their performance also cannot be always standardized as per our thinking. Intelligence is a concept which tries to understand and clarify the issues faced by a person in an organized way and it is a surprise why people do not understand the BASIC OR CORE INDIVIDUALITY OF A PERSON. The wisdom which one develops is over a period of time, after taking various experiences and forming due opinions regarding the situations. But most parents thrust their expectations over their children and make them function as per their aspirations. Unfortunately, the students' interest and parents' insistence do not match with one another and the friction starts. They do not realize that Intelligence Quotient is not a determining factor in a person's achievements, job or performance success and other overall factors like wealth and happiness which are even more important in one's life. This is the reason most parents keep on insisting on comparisons, mostly on the percentage scored. This is as if there is no value of individuality of the student. The competition is so fierce that it crosses the level of students and enters into parents' groups. This misconception about the student is largely seen everywhere and it takes away the mental peace of many generations at a time.

The said invention method takes care of this negative situation. It allows the child to compete with himself without thinking about many others. This improves his focus on the studies since he or she is not going to be compared with their peer group. The said invention method respects individuality of a person and creates space for oneself to improve on a consistent basis. A gradual improvement seen in the child's performance can also give a sense of satisfaction to the parents. Personalized development is the very center of the invention. Each child is bound to show some improvement over the earlier results. If parents offer their guidance and support at such a prime time, this growth will become sustainable over a period of time and will serve as a major factor in achieving bigger self-created targets. Thus parents will be able to avoid moulding their children into any kind of wrong structures.

The said invention method helps children set their own goals and focus over them. They start accepting the responsibility of their performance. When they accept this kind of ownership, they become more and more aware of their responsibilities. This will certainly offer some relief to the parents and they will be able to guide their wards in a better way and concentrate on other aspects of their growth and development. Parents will prove to be more helpful to the children, improving the relationships and bridging the gaps between the two generations. The said invention method can prove to be an asset in the sense that the guardians will be able to visualize the positive difference in their child. If case the result of invention method goes negative in some cases, they will be able to initiate corrective actions. The said invention method can even be worked out subject wise. This can facilitate focusing on more difficult subject so as to offer more and clearer guidance to the students. Thus the invention. Method and system for measurement of students' and educational institutions' performance can be a truthful indicator of real performance.

### Method and System For Measurement of Students' and Teachers and Educational Institutions' Performance:

There is a general tendency in the society to pass the blame of failure of students to the teachers. This is not only demoralizing the teachers' community, but also an injustice to the teachers who devote their lives for the noble profession of teaching. While the said invention method offers a yardstick for parents to measure the performance of their children, it can squarely create a proportionate responsibility on the teachers too. The said invention method will make the teachers also answerable to the students' performance. In fact, the said invention method can create basic standards for the teachers' performance too. The quality of teaching can be adjudged by a simple formula of claims of the said invention method. A new, objectively set yardstick or measurement tool will be available for understanding the difference between good teachers and otherwise. Presently the percentage of passing students and their highest scores is the only measure available for judging the performance of teachers. The said invention method can go a long way in fixing the objectives, take a continuous review of the achievements attained and also suggest corrective action in case the performances are dropping.

Presently, teachers are considered at par. The teaching standards are vague and do not justify the parents and students in many a cases. When the method of invention is introduced, it will be essential for each teacher to be updated on the knowledge front as well as on the efforts front. The teachers' meetings of a routine nature will have a new subject to discuss every time and setting goals and focusing on the same will be possible even for the teachers. Like a student can have personalized goals in education, the teachers too will have their subject wise goals of improved performance and this can go a long way in betterment of aggregate performances. This step can ensure better performance from all teachers as at present there is no such measuring tool available to judge them. The tendency to take up teaching as a mere job without any allotted responsibility will be no more existent. Many a people take up teaching as a last resort, when nothing else is available to them as an occupation. The said invention method will facilitate entry of enthusiastic, target oriented teaching community into the field of education and this can change the overall scenario in the country. Presently, it must be noticed that except in a few large cities and townships, the educational standards are extremely low. In some states, the situation is pathetic and if proper steps are not taken on priority basis, there is a chance that we will be losing a full generation due to lack of planning. Teachers will not be in a position to concentrate on a few intelligent students in the class. The overall performance of a class or school will be the indicator of their real efficacy.

There are other benefits of the invention method too. Most teachers focus only on their own subjects and neglect the other subjects and teachers. In the invention method, aggregate performance will be given priority importance and teachers will have to work as a team. In a team, there is less of ME and more of WE. This teamwork can create wonders in the life of students' community. While there will be healthy competition in the teachers, they will also be able to take up other related issues in the students' life. It is observed that more potent predictors of career success are various factors like how students handle stress, how they manage their time and their priorities, how they deal with frustrations and depressive tendencies, how they manage their own emotions, how they develop themselves socially in order to become better citizens and so on. As a trained person, a teacher has many an abilities, most of which are not utilized at all during a normal pattern. The method of invention can bring equal stress on Emotional Quotient, which is a more important determining factor as compared to Intelligence Quotient. While IQ is important at entry level in most careers, EQ plays a crucial role in the long term career. If the habits: of the invention method are imbibed at an appropriate time by the teachers in the students, the overall quality of life will certainly show an improvement.

### Method and System For Measurement of Students' Improvement and Teachers & Educational Institutions' Performance:

The present pattern in which the educational institutions are heading for is merely based on cut throat competition. It is very unfortunate that the competition from students' level has crossed institutions and even the boards of different states. The syllabi, the costs involved, the teaching standards, admission patterns, discipline matters etc. (this list is only inclusive and not exhaustive) drastically differ and there is no authorized body to analyze the effectiveness of educational policies in the country. A similar situation or even worse exists in many other countries too, which are in a developing stage. In short the overall circumstances represent chaos, haphazardness, unreasonableness, disorganized situation. This needs an overall cleansing and the invention method can offer a solution.

The invention method can offer a good benchmark for institutional performance. In most cases now, the performance of an institution is rated on the basis of students' performance rather than the institution's efforts. How much is the real contribution of the institution in the development of the student is always a question mark! In real educational market, where the competition is fierce, aggressive advertising and marketing techniques (many times overlooking the moral factors) are rampant. The invention method can better judge an institute's performance by setting targets and analyzing the achievements. The credit, which is eagerly taken by the institutions, will be a result of their own efforts rather than the students' efforts. This will be a more realistic indicator and no more be a manipulative game of numbers and marks. Competition will emerge, at various levels, local, national and even international. The present tendency to accept only high ranking students and making them cleverer will not last long.

Most parents carry a wrongful notion of certain renowned educational institutions. They are labeled as the best or the worst and so on. There is no logical, appropriate measure to decide this. Usually the percentage of marks scored by the last admission (at what point the admissions closed) becomes the criterion for judging. But does it indicate the real teaching'quality of the institution? This is difficult to comment upon as there is no common parameter to judge this. The invention method will offer another objectively designed tool to adjudge the real goodness or otherwise of an educational institution.

Emotional intelligence is the capacity to recognizing our own feelings and those of others, for motivating ourselves and for managing emotions well, in ourselves as well as in our relationships.

There are five main points concerning emotional intelligence. They are Self-awareness, Self-regulation, Self-motivation, Social awareness and Social skills. The inability to notice one's real or true feelings puts one to their mercy or slavery. People having greater understanding about their goals, focus and their overall performance targets and patterns can better guide themselves without much external support. They become self-reliant and are capable of better decision making. It is important to be open to positive and negative results encountered in the life. It is important to be emotionally balanced in both these situations. Pleasant and unpleasant circumstances are bound to be an integral part of one's life and one can never give it up fully however intelligent one may be. Emotional Intelligence includes the capacity to experience and tackle multiple and conflicting emotions at a time.

The invention method can create this awareness in students and the parents, right from the appropriate age of understanding the concept. The pressures faced by students now from various corners are multifarious. When the load of competing with many others is non-existent due to the invention method, a student will become mentally free to develop other positive skills. It will help him or her to add up more life skills which can shape a much better future for them. Distraction, anger, worry, jealousy and such other negative qualities will reduce to a marked extent. It is natural that a mature student will be able to shape and improve thinking in an appropriate way. It will direct his thinking towards right aims.

Qualities like Empathy will be developed. Empathy will lead to better counsel, greater emotional stability, more of interpersonal sensitivity and will finally lead to better school performance. The invention method will lead to learned optimism in the students and parents too. Optimistic thinking will lead to better success stories and higher attainments at all levels.

In short, the invention method can help students to achieve many other student skills in a comparatively easier manner. They will become better listeners, consistent workers in whatever they may do. They will self-analyze their performances and also be a part of the process of education by taking their own corrective measures. They will become emotionally stable and that itself is a great achievement. Decision making will be a better informed process in most of the cases, avoiding wrongful decisions and wastage of time, money and energy. This will further lead to better studentship and teaching and the overall implementation of the invention method at national and global levels can create fundamental changes in the approaches of people in the educational field.

We claim:

1. A method and system for measurement of:
(A) Students' improvement comprises-steps of:
a) Storing and recording the marks obtained by the a student in the previous examination;
b) calculating the maximum improvement possible (difference between maximum marks that is 100 percent less the marks obtained by the student in the previous examination) (say“b”)
) Storing and recording the marks in the current examination of the student;
d) calculating the difference between the current examination and the previous examination marks of a student (say“d”)
e) Calculating the percentage of change of the marks of the student to the scope of maximum improvement possible for the student (“d”/“b”×100);
Whereas the above system may also be used to measure improvement in a particular subject or a group of subjects.
(B) Teachers' performance comprises steps of:
a) Storing and recording average marks obtained by the relevant group of students in the previous examination;
b) calculating the maximum improvement possible in the group (difference between maximum marks that is 100 percent less the average marks obtained by the group of students in the previous examination) (say“b”)
c) Storing and recording the average marks in the current examination of the group of students;
d) calculating the difference between averages of the current examination and the previous examination marks of a group of students (say“d”)
e) Calculating the percentage of change of the average marks of the group of students to the scope of maximum improvement possible for the group of students. (“d”/“b”×100)
Whereas the above steps may be followed to measure performance of a teacher subject wise and also between or amongst the teachers irrespective of the subject taught by them and whereas this system may be applied to measure performance of a teacher on a year on year basis or between or amongst the teachers on a year on year basis.
(C) Educational institutions' performance comprises steps of:
a) Storing and recording average aggregate marks obtained by the students of a particular educational institution in the previous examination;
b) calculating the maximum improvement possible for the students of the educational institution in the group (difference between maximum marks that is 100 percent less the average aggregate marks obtained by the students of the educational institution in the previous examination) (say“b”)
c) Storing and recording the average aggregate marks in the current examination of the students of the educational institution;
d) calculating the difference between averages of the current examination and the previous examination aggregate marks of the students of the educational institution (say“d”)
e) Calculating the percentage of change of the average aggregate marks of the students of the educational institution to the scope of maximum improvement possible for the students of the educational institution. (“d”/“b”×100)
Whereas this system may be applied to measure performance of an educational institution on a year on year basis or between or amongst the educational institutions on a year on year basis and whereas this methodology may also be used to measure deterioration of performance of one or more students or teachers or institutions.
